(19) United States
(12) Patent Application Publication
(10) Pub. No.: US 2018/0130056 A1
(43) Pub. Date: May 10, 2018

(54) METHOD AND SYSTEM FOR TRANSACTION SECURITY

(71) Applicant: FORTICODE LIMITED, Melbourne, Victoria (AU)

(72) Inventor: Antony SMALES, Frankston (AU)

(73) Assignee: FORTICODE LIMITED, Melbourne, Victoria (AU)

(21) Appl. No.: 15/566,915

(22) PCT Filed: Apr. 15, 2016
(86) PCT No.: PCT/AU2016/050279

§ 371 Date: Oct. 16, 2017

Related U.S. Application Data
(60) Provisional application No. 62/149,270, filed on Apr. 17, 2015.

(51) Int. Cl. G06Q 20/40; H04L 9/32; H04L 9/08; G06F 9/451

(52) U.S. Cl. CPC G06Q 20/401; G06F 9/451; H04L 9/0861; H04L 9/3228

(57) ABSTRACT

A transaction includes one or more transaction messages transmitted to a transaction server via a first communications channel. Each transaction message includes at least one item of critical transaction data, A method of securing the transaction includes transmitting (606), to the transaction server via the first communications channel, a first transaction message. One-time security data is then generated (608), which defines one or more operations to be performed based upon the critical transaction data in order to generate a transaction verification code. The one-time security data (402, 403) is transmitted to the user via a second communications channel which is functionally distinct from the first communications channel. The transaction server receives, via the first communications channel, a second transaction message which includes a first transaction verification code provided (612) by the user responsive to receipt of the one-time security data via the second communications channel. A second transaction verification code is generated by performing the operations defined by the one-time security data based upon the critical transaction data included in the received first transaction message, and the first transaction verification code is compared (616) with the second transaction verification code. In the event of a mismatch between the first transaction verification code and the second transaction verification code, the transaction request is denied (622).

### FIELD OF THE INVENTION

The present invention relates to information security, and more particularly to enhancing the security of critical data exchanged via communications networks including, though not limited to, financial transaction details exchanged via the Internet.

### BACKGROUND TO THE INVENTION

Two Factor Authentication (TFA) is commonly used to authenticate communications conducted across communications networks, including the Internet. In basic authentication, a requesting entity (e.g. a user) presents some evidence of its identity to a second entity (e.g. a service provider, such as a bank). The use of TFA decreases the probability that the requesting entity is presenting false evidence of its identity, by requiring two different types of evidence, or factors, from among a finite list of preapproved factors. Conventionally, TFA requires the requesting entity to provide two of three possible factors, being something the requestor knows (such as a PIN or password), something the requestor has (such as an ATM card or a registered mobile phone), and something the user ‘is’ (e.g. a fingerprint or other biometric information).

One common category of TFA transforms a user's mobile phone into a token device, commonly using SMS messaging, an automated telephone call, or a dedicated application executing on the user's smartphone. A typical example is an Internet banking system, where the user may sign in to the bank's online portal using personal identifying information (e.g. a user name and password) on a personal computer or other Internet-enabled device. This identifying information is a knowledge factor within the TFA scheme. If the user has pre-registered a mobile phone number with their online banking service, then the mobile phone can serve as a possession factor. According to some such systems, when the user makes a request to perform a transaction (e.g. a transfer of funds, or a bill payment) via Internet banking. A randomly generated verification code is sent via SMS to the registered mobile phone number, and must be entered into the Internet banking interface in order to confirm and authorise completion of the transaction.

In the above example, SMS messaging is used as a backchannel to transmit a verification token independently of the main channel of communication between the user and the Internet banking portal. A fraudulent user thus requires possession not only of the identifying information of the genuine user, but also of the genuine user's mobile phone, in order to complete fraudulent transactions. However, this method of TFA is vulnerable to attacks in which the main communications channel itself has been compromised. In particular, such authentication techniques are vulnerable to man-in-the-middle (MIM) and man-in-the-browser (MIB) attacks. The mechanisms by which these attacks operate are illustrated in FIGS. 1(a), 1(b) and 2.

As illustrated in the block diagram 100 of FIG. 1(a), a user 102 employs, e.g., a desktop PC 104 in order to access a secure service portal (SSP) 106, such as in Internet banking portal, via the Internet 108. Web browser software 110 executes on the PC 104, providing the user with a graphical interface. The web browser 110 accesses the Internet 108 via a network interface 112, which generally comprises both the physical hardware required to connect to a local network, along with the network interface software (protocol stack) implementing the various communications protocols required to exchange information with other devices via one or more communications networks.

However, in the scenario 100 the user's PC 104 has been compromised, e.g. by some form of malware, whereby the browser 110 has not connected directly to the Internet banking portal 106, but instead to a fraudulent MIM server 114. This may be achieved either by tricking the user into clicking a link that redirects them to the fraudulent site 114, or by compromising the network interface configuration of the PC 104, such as the domain name service (DNS) subsystem, such that the genuine hostname of the Internet banking portal 106 is mapped to the IP address of the fraudulent server 114.

The fraudulent server 114 provides a web site which is a close imitation, or exact copy, of the Internet banking web site provided by the portal 106. Typically, a secure connection is required with the portal 106, such that SSL/TLS (i.e. the HTTPS protocol) is used to authenticate the server, and encrypt all communications. As a result, it is possible that the user 102 may receive a warning regarding a mismatch between the digital certificate provided by the fraudulent server 114 and the apparent domain, i.e. that of the user's banking service provider. However, many users may ignore or fail to notice such warnings.

Even this level of security can be compromised, for example by the MIB attack illustrated in the block diagram 120 of FIG. 1(b). In an MIB attack, a malicious software application 122 has infiltrated the user's PC 104, and interposed itself between the browser interface 110 and the network interface 112. The MIB malware has direct access to all data transferred to or from the browser interface 110, and can therefore read and/or modify information communicated between the user 102 and the Internet banking portal 106 independently of any encryption and authentication carried out between the network interface 112 of the PC 104, and the Internet banking portal 106.

FIG. 2 shows a timeline 200 of the mechanism of an attack in either the MIM or MIB scenarios illustrated in FIGS. 1(a) and 1(b). In the example shown, the user first enters transaction details 202, which may include a transfer amount ‘a’ and a recipient account number ‘A’. The transaction request is transmitted 204, but intercepted by the MIM/MIB 114/122. The fraudulent service modifies the request, for example changing the transaction amount to a higher value ‘b’ and the recipient account to a fraudster account number ‘B’. This modified transfer request is received via the Internet banking portal 106, and the transaction details are verified by the bank servers 208. The Internet banking portal 106 then returns a confirmation page 210, which includes the transaction details comprising the fraudulent amount ‘b’ and recipient account ‘B’. These are modified by the fraudulent software to reinsert the user-requested amount ‘a’ and recipient account ‘A’, and transmitted 212 to the browser 110, which updates its display 214. At this point, the user is unaware that the transfer actually requested to the Internet banking portal 106 is different from the originally entered transaction request.

At the same time, the bank servers generate a verification code 216, and transmit the code via a backchannel 218, such as an SMS messaging channel to the user's mobile phone. The user 220 receives the verification code, and enters 222 the verification code into the confirmation page displayed by the web browser 110. The confirmation code is then transmitted 224, and passed on 226 by the MIM/MIB 114/122 malware, to be received and validated 228 by the bank servers. This results in the fraudulent transaction of amount ‘b’ to account ‘B’ being validated and authorised, and the Internet banking portal 106 then serves a further transaction confirmation page 230. The malware 114/122 may again modify the confirmation page 232, in order to conceal the fraudulent transaction. Indeed, sophisticated malware 114/122 will continue to present the user with consistent false information throughout their Internet banking session, in order to delay discovery of fraudulent transactions until such time as the money can be withdrawn or transferred from the fraudster's account ‘B’.

As will be appreciated from the above examples, improved methods and systems for transaction security are required that are able to defeat, or at least to mitigate the risks associated with, MIM, MIB, and other attacks based on a compromised main communications channel. The present invention is directed to providing such improvements.

### SUMMARY OF THE INVENTION

In one aspect, the invention provides a method of securing a transaction which includes one or more transaction messages transmitted to a transaction server via a first communications channel, the one or more transaction messages including at least one item of critical transaction data, wherein the method comprises:

receiving, by the transaction server via the first communications channel, a first transaction message, corresponding with a transaction request of a user, which includes an item of critical transaction data;

responsive to receipt of the first transaction message, generating one-time security data defining one or more operations to be performed based upon the critical transaction data in order to generate a transaction verification code;

transmitting the one-time security data to the user via a second communications channel which is functionally distinct from the first communications channel;

receiving, by the transaction server via the first communications channel, a second transaction message which includes a first transaction verification code provided by the user responsive to receipt of the one-time security data via the second communications channel;

generating a second transaction verification code by performing the operations defined by the one-time security data based upon the critical transaction data included in the received first transaction message;

comparing the first transaction verification code with the second transaction verification code; and

in the event of a mismatch between the first transaction verification code and the second transaction verification code, denying the transaction request.

Advantageously, embodiments of the invention provide technical arrangements whereby a verification code can be independently generated in two remote locations, e.g. at an end-user location and at a security system location. The verification code is dependent upon at least one item of critical transaction data such that any modification of the critical transaction data in transit via the first communications channel may be detected as a mismatch in the independently-generated verification codes. The second channel is used to transmit one-time security data, which is used to generate the verification code. As a result, compromising the security provided by embodiments of the invention requires infiltration of both the first and second communications channels. In particular, an MIM or MIB attacker which has infiltrated the first channel, over which the primary transaction messages are exchanged, is unable to reliably generate a correct verification code corresponding with altered critical transaction data, such as a destination bank account number, in the absence of access to the second channel.

According to embodiments of the invention, the one-time security data includes a security matrix which comprises a mapping between each symbol within a symbol set associated with the critical transaction data and a code value which is randomly selected from a code set, whereby the operations to be performed based upon the critical transaction data comprise generating a substitution code by replacing one or more symbols of the critical transaction data with the associated code value defined by the mapping. The security matrix may be valid only for a duration of the transaction.

The use of a security matrix mapping, e.g., symbols comprising the critical transaction data (such as the digits ‘0’ to ‘9’, in the case that the critical data is an account number) to a corresponding random selection of symbols from a code set (such as the complete set of upper and lower case letters, and the numbers) advantageously enables the user to generate the verification code without technological assistance, this being simply the mapping of specified digits of the account number to the corresponding code symbols using the matrix. Accordingly, the security data may be transmitted via a second channel including a cellular mobile network link via SMS messaging, for example.

The one-time security data may further include supplemental security data which defines one or more additional operations to be performed upon the substitution code in order to generate the transaction verification code. For example, the one or more additional operations defined by the supplemental security data may comprise selecting a subset of symbols of the substitution code for inclusion in the transaction verification code. An example of supplemental security data is a specification defining selected digits of an account number to be used in generating the verification codes. Advantageously, the use of supplemental security data increases the level of the challenge to an infiltrator of the first communications channel in attempting to derive, or guess, a correct verification code corresponding with altered critical transaction data.

In embodiments of the invention, the transaction verification code may be derived from a hash of a code produced by performing operations defined by the one-time security data based upon the critical transaction data.

In some embodiments, the one-time security data is transmitted via the second communications channel to a user device for processing by a software application executing on the user device. The software application may be configured to:

receive the one-time security data via the second communications channel;

request and receive from the user, via a user interface of the user device, the critical transaction data required for generation of the transaction security code by operations defined in the one-time security data;

generate the transaction verification code by performing the operations defined by the one-time security data based upon the critical transaction data received from the user; and

provide to the user, via the user interface of the user device, the generated transaction verification code.

For example, the software application (‘app’ ) may be configured to execute on a smart device (e.g. a smartphone or tablet of the user). The app can then receive the security data via the functionally distinct second communications channel, prompt the user to provide the critical transaction data (such as an account number), generate the transaction verification code, and display a human-readable representation of the transaction verification code. A particular advantage resulting from the use of an app is thus that the operations to be performed based upon the critical transaction data entered by the user may be more complex, and therefore potentially more secure, than the more limited set of operations that may be performed in practice by a user without the benefit technological assistance. A further advantage is the possibility of reducing the occurrence of human error.

In another aspect, the invention provides a computer server system comprising a processor which is coupled to a memory store including executable program instructions which, when executed, cause the processor to:

provide a secure service portal accessible to a user via a first communications channel and configured to facilitate transactions in response to transaction requests of the user;

responsive to receiving, via the first communications channel, a first transaction message, corresponding with a transaction request of the user, which includes an item of critical transaction data, generate one-time security data defining one or more operations to be performed based upon the critical transaction data in order to generate a transaction verification code;

receive, via the first communications channel, a second transaction message which includes a first transaction verification code provided by the user responsive to receipt of the one-time security data, which has been transmitted to the user via a second communications channel which is functionally distinct from the first communications channel;

generate a second transaction verification code by performing the operations defined by the one-time security data based upon the critical transaction data included in the received first transaction message;

compare the first transaction verification code with the second transaction verification code; and

in the event of a mismatch between the first transaction verification code and the second transaction verification code, deny the transaction request.

In some embodiments of the invention the, executable program instructions, when executed, cause the processor to generate the one-time security data by:

transmitting a request for generation of the one-time security data, via a secure communications channel, to a security system which is configured to generate the one-time security data.

Advantageously, the use of a separate security system to generate the security data enables the associated security services to be employed by multiple server systems, without requiring the full security functionality to be replicated in each server system. Furthermore, end-users may register with a single security system provider, and may establish associated user preferences with the single security system provider. User preferences may include preferences that modify or determine aspects of the operations to be performed based upon the critical transaction data in order to generate a transaction verification code. In this way, an additional level of security may be implemented, in that even if two transactions are protected by the same security data, the application of different user preferences may result in different transaction verification codes.

In some embodiments, the executable program instructions, when executed, cause the processor to generate the second transactrion verification code, and to compare the first transaction verification code with the second transaction verification code, by:

transmitting the first transaction verification code, via a secure communications channel, to a security system which is configured to generate the one-time security data; and

receiving from the security system, via the secure communications channel, a response message comprising an indication of a result of a comparison between the first transaction verification code and the second transaction verification code which has been generated by the security system performing the operations defined by the one-time security data based upon the critical transaction data included in the received first transaction message.

In a further aspect, the invention provides a security system comprising a processor which is coupled to a memory store including executable program instructions which, when executed, cause the processor to:

receive, from a remote processor via a secure communications channel, a request for generation of one-time security data;

generate one-time security data defining one or more operations to be performed based upon critical transaction data of a transaction of a user in order to generate a transaction verification code;

transmit, to a device of the user via a communications backchannel, a security message comprising the one-time security data;

receive, from the remote processor via the secure communications channel, a first transaction verification code generated by the user based upon the critical transaction data, and provided to the remote processor via a primary communications channel;

generate a second transaction verification code by performing the operations defined by the one-time security data based upon critical transaction data included in a transaction message sent by the user to the remote processor via the primary communications channel;

compare the first transaction verification code with the second transaction verification code; and transmit, to the remote processor via the secure communications channel, a response message comprising an indication of a result of the comparison between the first transaction verification code and the second transaction verification code.

The executable program instructions, when executed, may cause the processor to transmit the security message comprising the one-time security data to the device of the user via the remote processor.

In yet another aspect, the invention provides a portable computing and communications device comprising a processor which is coupled to a memory store including executable program instructions which, when executed, cause the processor to:

receive, via an associated communications channel, one-time security data defining one or more operations to be performed based upon critical transaction data in order to generate a transaction verification code;

present to a user, via a user interface of the portable computing and communications device, a prompt for the user to enter the critical transaction data;

receive from the user, via the user interface, the critical transaction data;

generate the transaction verification code by performing the operations defined by the one-time security data based upon the critical transaction data; and

present to the user, via the user interface, a human-readable representation of the transaction verification code.

The executable program instructions, when executed, may cause the processor to generate the transaction verification code in accordance with a method that includes computing a hash of transformed critical transaction data.

In still another aspect, the invention provides a computer program product comprising a computer-readable medium having executable program instructions stored therein which, when executed by a processor which is coupled to an associated communications channel, cause the processor to:

receive, via the associated communications channel, one-time security data defining one or more operations to be performed based upon critical transaction data in order to generate a transaction verification code;

present to a user, via a user interface, a prompt for the user to enter the critical transaction data;

receive from the user, via the user interface, the critical transaction data;

generate the transaction verification code by performing the operations defined by the one-time security data based upon the critical transaction data; and

present to the user, via the user interface, a human-readable representation of the transaction verification code.

Further details of the principles of operation of the invention, along with various applications and configurations, and their associated benefits and advantages, will be appreciated from the following disclosure of various embodiments. These embodiments are, however, provided by way of example, and are not intended to be limiting of the overall scope of the invention as defined in any of the preceding statements, or in the claims appended hereto.

### BRIEF DESCRIPTION OF THE DRAWINGS

Embodiments of the invention will be described with reference to the accompanying drawings, wherein like reference numerals indicate like features, and in which:

FIGS. 1(a) and (b) show block diagrams illustrating man-in-the-middle (MIM) and man-in-the-browser (MIB) scenarios, respectively, according to the prior art;

FIG. 2 illustrates a timeline of an attack based on an MIM/MIB exploit according to the prior art;

FIG. 3 is a block diagram illustrating an exemplary system architecture embodying the invention;

FIG. 4 illustrates a timeline of a verification code generation and exchange embodying the invention;

FIG. 5 is a timeline of communications between a secure service portal (SSP) and a security system embodying the invention;

FIG. 6 shows a flowchart illustrating a transaction security method embodying the invention;

FIG. 7 shows exemplary screen displays of a smart device application embodying the invention; and

FIG. 8 is a schematic diagram of a system for establishing a trusted backchannel between a secure service provider and a smart device application embodying the invention.

### DETAILED DESCRIPTION OF EMBODIMENTS

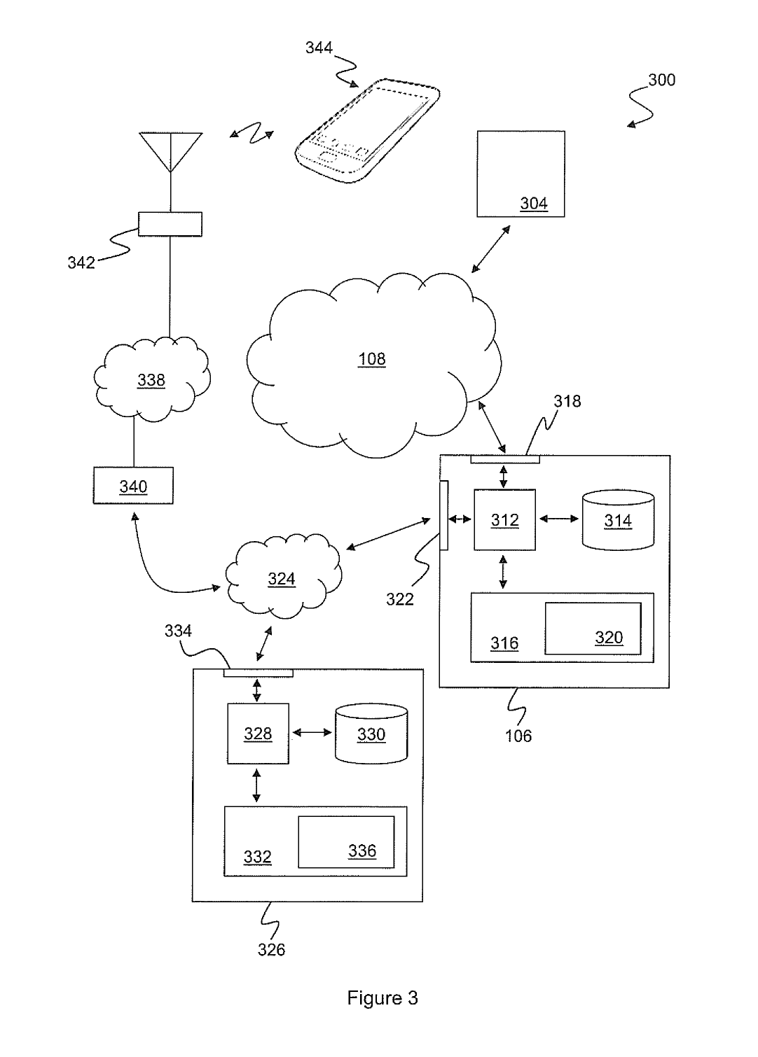

FIG. 3 is a block diagram illustrating a system 300 embodying the present invention. A public communications network 108, such as the Internet, is employed for messaging between client devices 304 and a secure service portal (SSP) 106. Generally speaking, the client devices 304 may be any suitable computing or processing appliances having the ability to communicate via the Internet 108, for example using web browser software and/or other connected applications. Similarly, other components shown in the system 300 including the SSP 106, generally comprise one or more processing, computing and/or storage devices. In this specification, terms such as ‘processor’, ‘computer’, and so forth, unless otherwise required by the context, should be understood as referring to a range of possible implementations of devices or apparatus comprising a combination of hardware and software. This includes single-processor and multi-processor devices and apparatus, including cooperating hardware and software platforms that may be co-located or distributed. Hardware may include conventional personal computer architectures or other general purpose hardware platforms. Software may include commercially available operating system software in combination with various application and service programs. Alternatively, computing or processing platforms may comprise custom hardware and/or software architectures. For enhanced scalability, computing and processing systems may comprise cloud computing platforms, enabling physical hardware resources to be allocated dynamically in response to service demands. While all of these variations fall within the scope of the present invention, for ease of explanation and understanding the exemplary embodiments described herein are based upon single processor general purpose computing platforms, commonly available operating system platforms, and/or widely available consumer products, such as desktop PCs, notebook or laptop PCs, smart phones, and so forth.

Software components embodying features of the invention may be developed using any suitable programming language, development environment, or combinations of languages and development environments, as will be familiar to persons skilled in the art of software engineering. For example, suitable software may be developed using the C programming language, the Java programming language, the C++ programming language, and/or a range of languages suitable for implementation of network or web-based services, such as JavaScript, HTML, PHP, ASP, JSP, and so forth. These examples are not intended to be limiting, and it will be appreciated that other convenient languages or development systems may be employed, in accordance with system requirements.

In the exemplary system 300, the SSP 106 comprises a processor 312. The processor 312 is interfaced to, or otherwise operably associated with, a non-volatile memory/storage device 314. The non-volatile storage 314 may be a hard disk drive, and/or may include a solid-state non-volatile memory, such as read-only memory (ROM), flash memory, or the like. The processor 312 is also interfaced to volatile storage 316, such as random access memory (RAM), which contains program instructions and transient data relating to the operation of the SSP 106.

In a conventional configuration, the storage device 114 maintains known program and data content relevant to the normal operation of the SSP 106. For example, the storage device 314 may contain operating system programs and data, as well as other executable application software necessary to the intended functions of the SSP 106. The storage device 314 also contains program instructions which, when executed by the processor 312, instruct the SSP 106 to perform operations relating to an embodiment of a transaction security system according to the invention. In operation, instructions and data held on the storage device 314 are transferred to volatile memory 316 for execution on demand.

The processor 312 is also operably associated with a communications interface 318 in a conventional manner. The communications interface 318 facilitates access to the public data communications network 108.

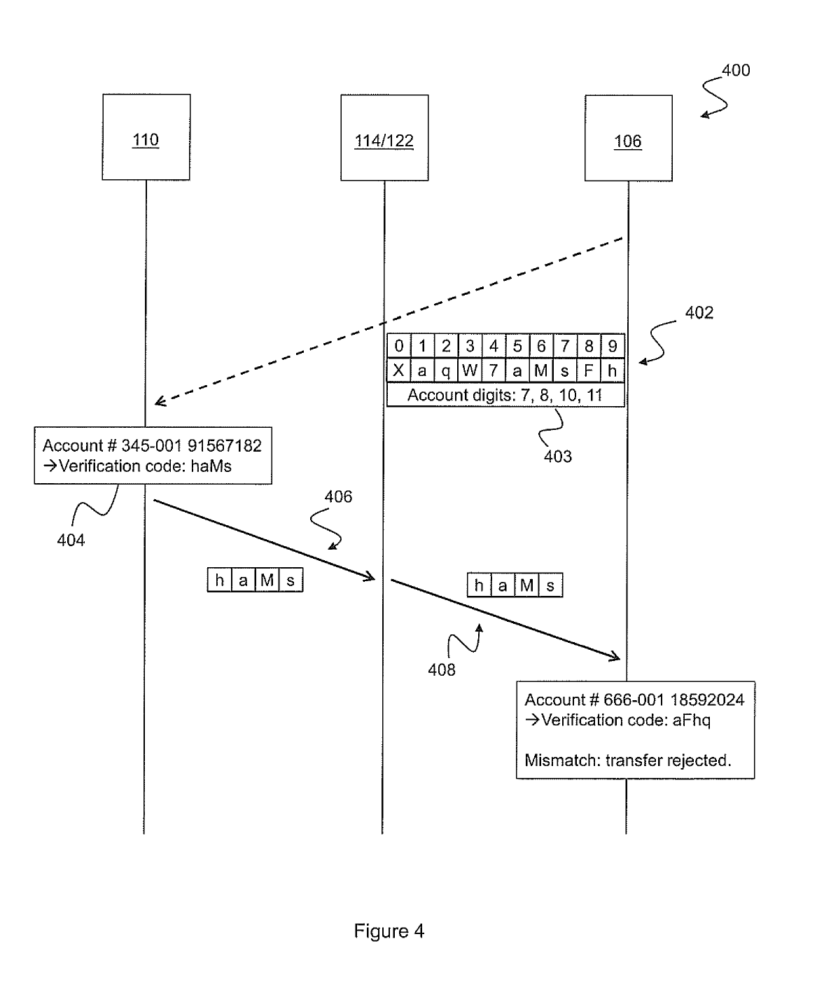

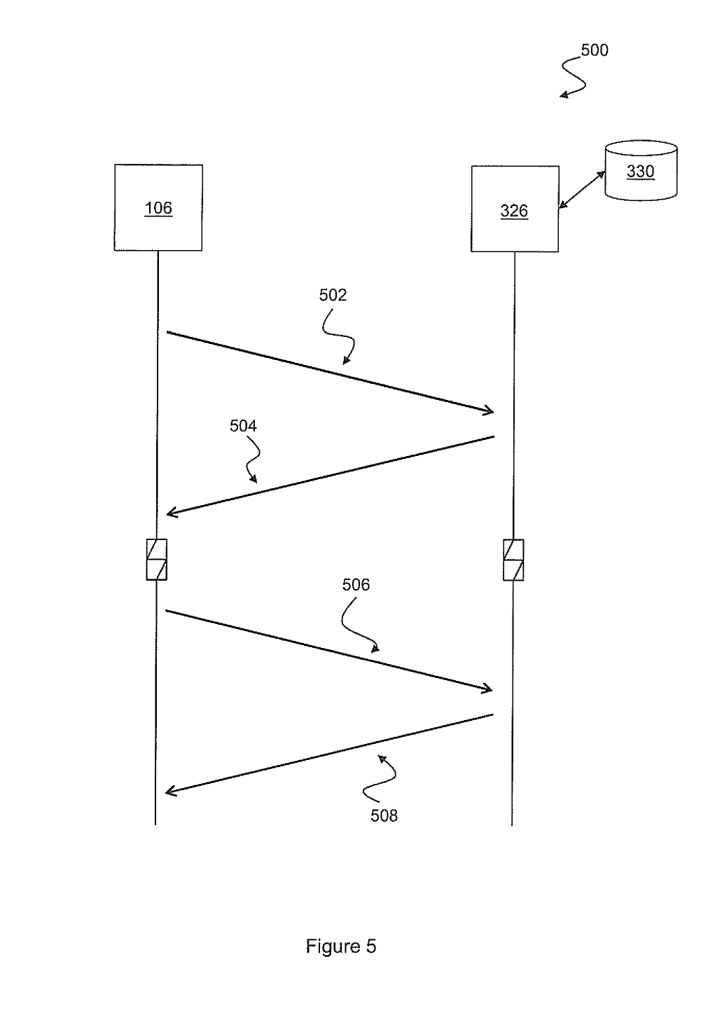

In use, the volatile storage 316 includes a corresponding body 320 of program instructions configured to perform processing and operations embodying features of the present invention, comprising various functional elements of the system as described below, particularly with reference to the timelines illustrated in FIGS. 4 and 5.

The SSP 106 may comprise a further network interface 322 which provides access to a private network 324, which is used to communicate securely with other elements of the system 300 that are not intended to be directly accessible via the public network 108. The private network 324 may be physically distinct from the public network 108, or may be implemented as a virtual private network (VPN) physically employing the infrastructure of the public network 108, whereby the network interface 322 is a virtual network interface which may share hardware components with the public network interface 318. It will therefore be understood that where the term ‘network interface’ is used throughout this specification, unless otherwise required by the context, it refers to a combination of physical hardware and/or network interface software (protocol stack) implementing the various communications protocols required to exchange information with other devices via one or more corresponding physical or virtual communications networks.

As illustrated in the system 300, the SSP 106 is able to communicate via the private network 324 with a security system 326. The security system 326 is also a server platform which is depicted in simplified form within the block diagram of FIG. 3. The security system 326 comprises a processor 328, which is interfaced to, or otherwise operably associated with, a further non-volatile memory/storage device 330. The processor 328 is also interfaced to volatile storage 332, which contains program instructions and transient data relating to the operation of the security system 326.

The processor 328 is operably associated with a communications interface 334, via which it is able to communicate over the private network 324 with the SSP 106.

In use, the volatile storage 332 includes a corresponding body 336 of program instructions configured to perform processing and operations embodying features of the present invention, comprising various functional elements of the system as described below, particularly with reference to the timeline of FIG. 5.

The general function of the security system 326 is to receive requests from the SSP 106, and to generate one-time security data that may be used for the generation of verification codes that are robust against MIM and MIB attacks. In some embodiments, as described in greater detail below with reference to FIG. 4, the one-time security data comprises verification matrices or tables.

The security system 326 maintains a database, e.g. within the non-volatile storage 330, of user account information. This user database includes a record for each end-user of the system 300, i.e. the users operating the client appliances 304. Each user record comprises a unique user identifier (ID), and an associated keyword or password. The user record also includes user preferences associated with the use of the security system 326, and all secure systems, devices and services, such as the SSP 106, which make use of the services provided by the security system 326. For example, the use of a security system having features corresponding with the system 326 for user authentication (e.g. secure login) is disclosed in commonly assigned U.S. Pat. No. 8,869,255, issued on 21 Oct. 2014.

The private network 324 is also connected to a telecommunications service provider network 338, such as the public switched telephony network (PSTN) via a network termination unit (NTU) 340. This enables the SSP 106, the security system 326, and/or any other system connected to the private network 324, to engage in communications with end-users via the PSTN 338. Such communications may comprise voice telephony calls, automated telephony calls, and SMS messaging. In the exemplary system 300 the PSTN 338 is shown connected to a cellular mobile base station 342, facilitating communications with a mobile device 344 of an end-user who is also accessing the SSP 106 via a client device 304.

In accordance with the system 300, and end-user therefore has a primary-or main-channel of communications between a client apparatus 304 via the public network 108 to the SSP 106, which may provide a secure service, such as an Internet banking service. Additionally, there is a secondary channel-also termed a backchannel-connecting secure systems on the private network 324 via the PSTN 338 to an end-user device 344. This backchannel may be used to transmit one-time security data, e.g. a security matrix or table as described in greater detail with reference to FIG. 4, such that it is not accessible to any MIM, MIB, or other compromising entity disposed in the main channel via the public network 108.

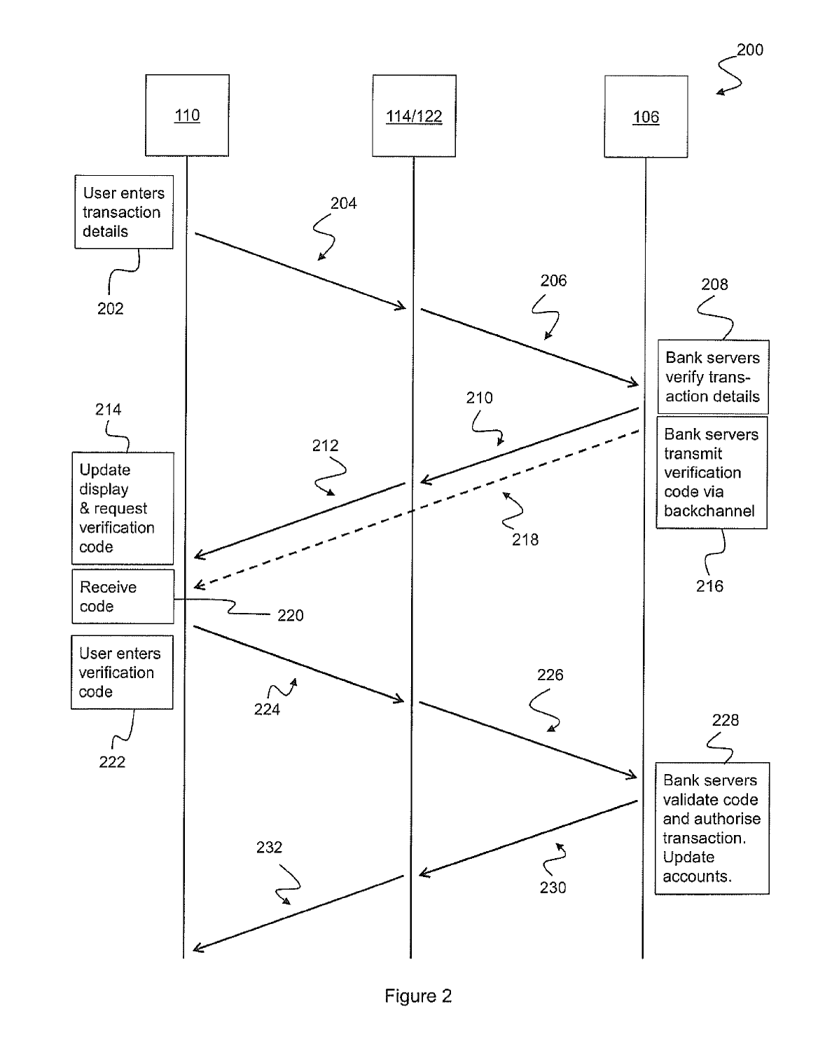

Turning now to FIG. 4, there is shown a timeline 400 illustrating verification code generation and exchange embodying the invention. The transmissions in the timeline 400 correspond with the backchannel transmission 218, and the following main-channel confirmation transmissions 224, 226, as depicted in the prior art implementation 200 of FIG. 2.

In accordance with embodiments of the present invention, instead of generating a fixed verification code that is transmitted via the backchannel to the end-user client device, the SSP 106 issues a request to the security system 326 for the generation of one-time security data. In the example shown in FIG. 4, a one-time security matrix or table 402 is generated, which comprises a mapping between a set of K key symbols (shown on the top row of the table 402) and a corresponding set of N code symbols (shown on the lower row of table 402). This mapping is effectively random, or pseudo random, and cannot be predicted in advance by the SSP 106, or by any other entity within the exemplary system 300. In this example, the one-time security data also includes supplemental security data 403, the purpose of which is explained below.

In requesting the generation of the security data 402, the SSP 106 may identify the corresponding user of the client device 304, such that the security matrix 402 may be generated in accordance with any relevant user preferences, as well as in accordance with requirements of the SSP 106. User and/or SSP preferences or requirements may comprise such matters as the particular set of symbols making up the K key symbols on the top line, and the number and nature of code symbols employed in the mapping on the lower line of the table 402. In general, N may be less than, equal to, or greater than K, and the mapping between key symbols and code symbols need not be unique, i.e. code symbols may be reused. Embodiments of the invention endeavour to significantly reduce the probability that an MIM or MIB attacker able to intercept a corresponding verification code (e.g. generated as described below) is able to generate a corresponding fraudulent verification code without intercepting the security matrix 402.

In accordance with embodiments of the invention, the key symbol set is chosen to correspond with elements of one or more critical components of the user's transaction. For example, in the case of an Internet banking transfer the recipient account number is critical, because if it can be fraudulently modified by the MIM/MIB attacker then funds may be transferred to an unauthorised account. Supposing the account number consists of a number of digits between ‘0’ and ‘9’, then this set of digits comprises the key symbol set in the upper row of the matrix 402. The user may then be requested to generate a verification code based on some or all digits of the critical recipient account number. The code is generated by substituting each digit of the account number with the corresponding code symbol from the bottom row of the security matrix 402. Additionally, the supplemental security data 403 identifies four digits (the seventh, eighth, tenth and eleventh) of the recipient account number to be used in generating a verification code for the transaction.

Additionally, the user may perform some manipulation on the account digits (i.e. key symbols) and/or the code symbols in the course of generating the verification code, in accordance with associated user preferences maintained by the security system 326. Such manipulations and preferences will be described in greater detail below, however for the present example the simple case of a direct mapping between key symbols and code symbols is explained.

The exact format in which the security matrix mapping 402 is transmitted to the end-user is not critical, and may depend upon the nature of the backchannel. For example, the user device 344 may be capable of displaying information in a graphical format, in which case the security matrix 402 may be transmitted in a corresponding graphical format. Alternatively, if the backchannel is an SMS backchannel, it may be more convenient to transmit a representation of the security matrix 402 in a text format, e.g. ‘0=X; 1=a; 2=Q; . . . ’ and so forth.

Regardless of the format in which the security matrix 402 is transmitted, the timeline 400 illustrates the generation of a verification code in accordance with the one-time security data 402, 403, and the recipient account number 345-001 91567182. As shown at 404, the corresponding verification code is ‘haMs’, obtained by mapping the seventh, eighth, tenth and eleventh digits of the account number (‘9’, ‘1’, ‘6’ and ‘7’) to the corresponding symbols in the matrix 402, i.e. ‘h’, ‘a’, ‘M’, ‘s’. This verification code is entered by the user into a confirmation screen presented on their web browser, and transmitted 406 via the main channel.

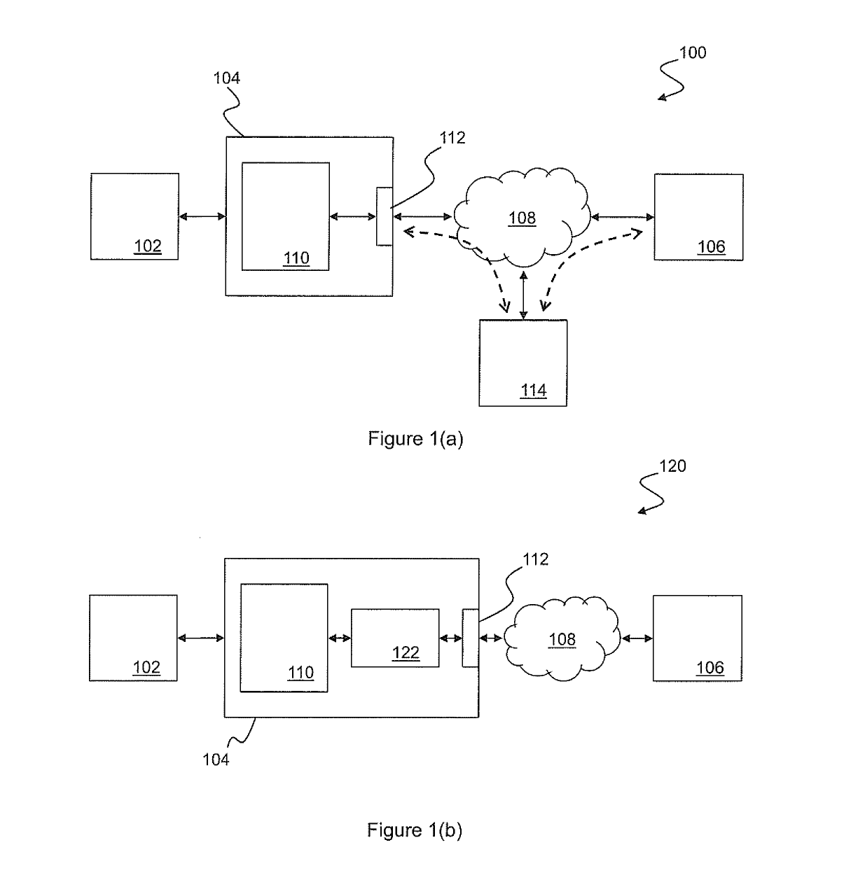

The code is intercepted by the MIM/MIB 114/122 which, in accordance with a conventional implementation, simply passes this code through via transmission 408 without making any changes. However, since the MIM/MIB 114/122 had previously modified the recipient account number in order to falsify the transaction, the code passed through to transmission 408 from transmission 406 does not match the account number as originally received by the SSP 106. Thus, when the SSP 106 receives and attempts to validate the verification code 404, this validation will fail, and the fraudulent modification of the critical transaction information will be detected. Furthermore, even if the MIM/MIB attacker 114/122 is aware that a security matrix mapping system is employed, it cannot generate a verification code to match the fraudulently modified recipient account number without access to the backchannel in order to obtain the one-time security data 402, 403. Accordingly, systems and methods embodying the present invention are able to thwart, or at least to significantly mitigate, existing MIM/MIB attacks, as illustrated and described above in relation to FIGS. 1(a), 1(b) and 2.

FIG. 5 shows a timeline 500 illustrating communications between an SSP 106 and a security system 326 according to embodiments of the invention. The transmissions shown in the timeline 500 occur prior to, and following, the exchange shown in the timeline 400 of FIG. 4. These transmissions enable the SSP 106 to utilise services provided by the security system 326 to generate the security matrix 402, and to validate the verification code received back from the end-user. As will be appreciated, however, it is not necessary that the security system 326 be implemented as a separate remote service from the SSP 106. All of the functionality illustrated and associated with the security system 326 could alternatively be implemented as a component of the SSP 106. However, the implementation of the security system 326 as a remote service has the advantage, at least, of enabling the associated security services to be employed by multiple SSPs 106, without requiring the full functionality to be replicated in each case. Furthermore, end-users may register with a single security system provider, and establish their associated user preferences within the database 330, and then employ the same account and preferences across multiple SSP providers.

As shown in the timeline 500, when the SSP 106 has received requested transaction details which require validation, it generates a request 502 which is transmitted to the security system 326. This request may identify any additional information or parameters required by the security system 326 in order to generate compatible one-time security data. For example, the request 502 may include an identification of the user, so that the security system 326 may incorporate any relevant user preferences from the database 330 into the generation of the security matrix. The request 502 may also include any parameters supplied by the SSP 106 that are specific to this particular validation request. For example, in the case that the one-time security data comprises a security matrix, the parameters may include an identification of the key symbol set, which for a validation based upon a recipient account number may comprise only the digits between ‘0’ and ‘9’. In other contexts, however, the transaction information used in the generation of a verification code may include such things as an account name, such that the key symbol set may be larger, for example including all alphabetic characters and selected special characters. Additionally, the request 502 may include parameters defining the code symbol set, and/or the number of symbols N that should be employed in the code symbol set.

Upon receipt of the request 502, the security system 326 generates a corresponding security matrix, and a response 504 including the matrix is transmitted. The SSP 106, or another component of the system 300, will then use the security matrix returned in the response 504 to generate a message to be transmitted to the user via the backchannel to the user device 344.

The user then generates and enters the verification code 404, which is transmitted back to the SSP 106 as illustrated in the timeline 400. The SSP 106 then generates a further request 506 to the security system 326. This further request 506 is for the security system 326 to validate the verification code received via the main channel, and to return a further response 508 indicating whether the verification code validates successfully or not. The message 506 transmitted to the security system 326 may include parameters necessary for the security system 326 to validate the verification code. These may include an identifier of the user, the returned verification code itself, and the relevant transaction details, such as the recipient account number, or other critical information, which has been used to generate the verification code. The security system 326 then uses its record of the one-time security data previously generated and returned via response 504, along with the transaction details, and any associated user preferences retrieved from the database 330, in order to regenerate the verification code that should have been entered and returned by the end-user. This locally generated verification code may then be compared with the code included in the request 506, in order to determine whether or not the transaction is validated. The result of the comparison is returned in the response 508. The SSP 106 is then able to determine whether or not to execute the transaction, in accordance with the validation result 508.

As has been noted above, in some embodiments of the invention, users may be registered with the security system 326, and have associated user preference data stored in a user account record defining additional manipulations to be performed on the key symbols and/or code symbols in order to generate the verification code 404. A non-exhaustive list of possible manipulations that may be offered to users and stored within their account records is listed below, and in general suitable manipulations for modifying verification codes may comprise a subset of manipulations available when the security system 326 is also configured to provide authentication (e.g. secure login) services, such as are described in the commonly assigned U.S. Pat. No. 8,869,255. Indeed, in some embodiments the security system 326 may be used by an SSP 106 for multiple purposes, e.g. for initially authenticating the user, as part of the login process, and subsequently for validating transactions requested by the user. In this way, the MIM/MIB attacker 114/122 may also be prevented from acquiring the user's password during the initial login process.

Manipulations that may be provided by way of user preferences include:
a positive offset, i.e. an increment to be applied to each code value when generating the verification code 404 (where required, numbers may wrap such that 9+1=0 and letters may wrap such that Z+1=A);
a negative offset, i.e. a decrement to be applied to each code value (if required, a reverse wrapping may be employed);
an increasing positive increment, or positive ‘crawl’, whereby an increment is applied to each code value, as with a positive offset, however the magnitude of the increment itself increases with each element of the verification code;
an increasing negative increment, or negative ‘crawl’, whereby a decrement is applied to each code value as for a negative offset, however the magnitude of the decrement increases with each element of the verification code; and/or
a mask, identifying a subset of code values within a full code that should be used to formulate the verification code (a mask therefore performs a similar function to the supplemental security data 403 described in the example above, but on a ‘per-user’ rather than ‘per transaction’ basis).

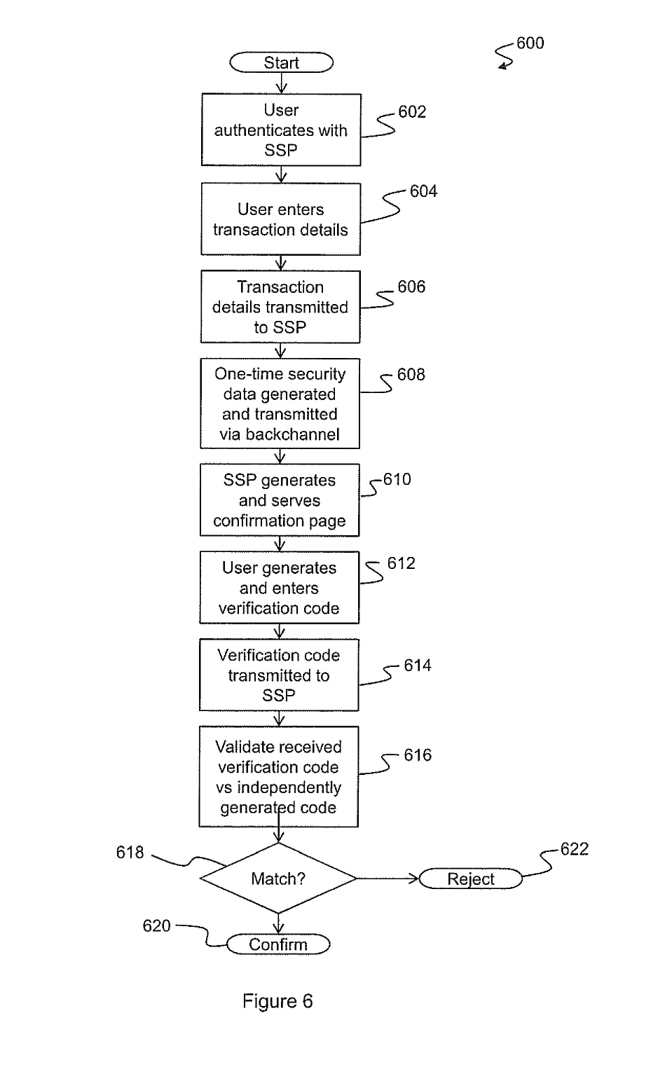

Turning now to FIG. 6, there is shown a flowchart 600 illustrating a transaction security method embodying the invention, corresponding with the timelines and general system architecture described above.

At step 602, the user authenticates with the SSP 106. This authentication may include signing in to the SSP 106 using identifying and authenticating information, such as a user ID and a password. Optionally, the authentication process may be further secured by employing the services of the security system 326 in a manner such as is described in U.S. Pat. No. 8,869,255.

At step 604, the user wishes to conduct a transaction, and enters transaction details, including critical details such as, e.g. in the case of a funds transfer via an Internet banking portal, a recipient account number and a transaction amount. At step 606 the transaction details are transmitted to the SSP 106, at which point they are exposed to a potential interception by an MIM/MIB attacker 114/122.

At step 608, one-time security data is generated, for example via interactions 502, 504 between the SSP 106 and the security system 326. The resulting security data is transmitted via the backchannel.

At step 610, the SSP 106 generates and serves a confirmation page to the end-user, which includes a facility for the user to enter a verification code. The user determines the appropriate verification code in accordance with the security data, the critical transaction details, and any applicable user preferences, and then enters the code at step 612.

At step 614, the verification code entered by the user is transmitted to the SSP 106, at which point it is subject to potential interception and retransmission by an MIM/MIB attacker 114/122.

At step 616, the verification code is validated, for example via the interactions 506, 508 between the SSP 106 and the security system 326 as illustrated in FIG. 5. Depending upon the result of this validation, the transaction is either confirmed or rejected at step 618.

While the above description of embodiments serves to illustrate the principles of the invention, it will be appreciated that many variations are possible, including variations which provide additional convenience to end-users. For example, users with ‘smart devices’, such as smartphones or tablets, may be provided with a dedicated application (or ‘app’) to assist in generation of the verification codes. For example, a dedicated app may be able to receive communications on behalf of the user from the SSP 106 and/or the security system 326. These communications may be received, for example, via SMS from a trusted originating number, or via a secure encrypted channel that may be established via the Internet, or some other communications network, based upon secret information (e.g. private keys) known only to the security system 326 and to appropriately secured code elements within the app.

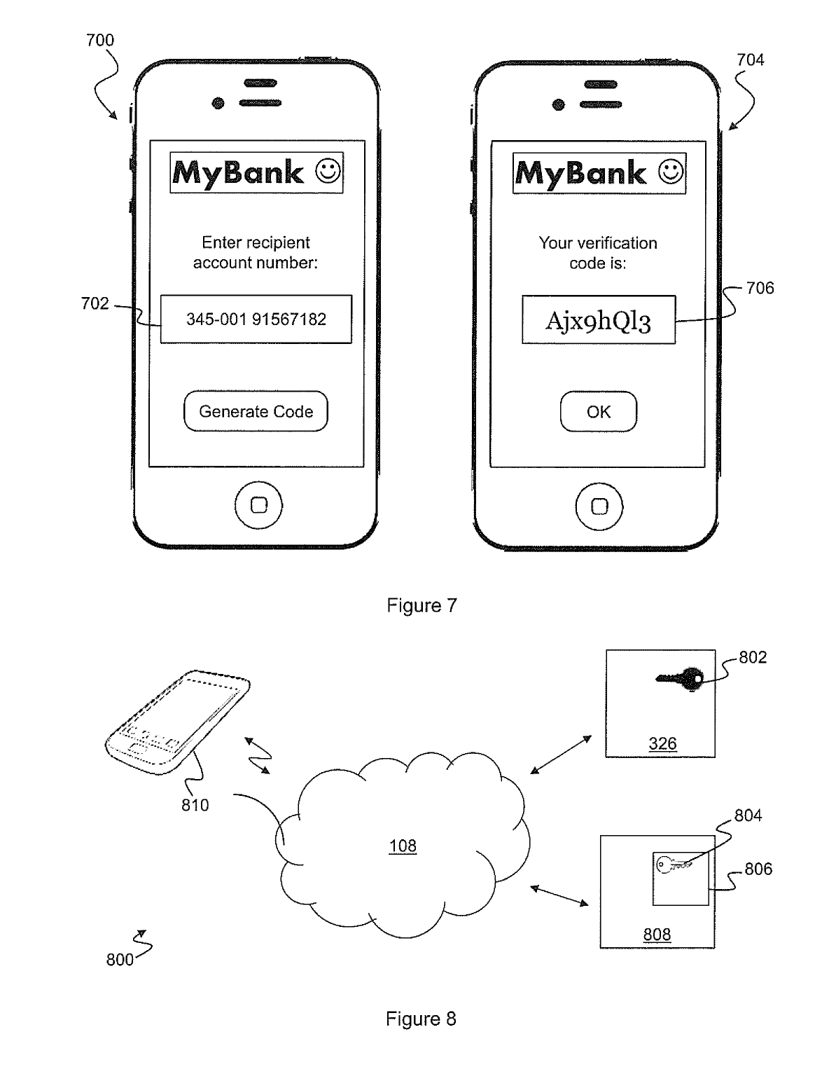

FIG. 7 illustrates exemplary screen displays of a smart phone app embodying the invention. The user may initiate execution of the app, by opening it prior to initiating a transaction with the SSP 106, or the app may monitor the backchannel and automatically open upon receipt of security matrix information 402. At this time, the display 700 may appear, prompting the user, via a text entry box 702, to enter the relevant transaction details, e.g. the recipient account number of an Internet banking funds transfer. Once in possession of this information, along with the received security matrix data, the app is able to compute the verification code and present it to the user for entry to the confirmation page, i.e. at step 612 of the process 600. A corresponding exemplary screen display 704 provides the corresponding verification code 706 to the user.

In embodiments in which the user employs a smartphone app or similar to generate a verification code 706, more complex computations may be employed than would be practical when the user is required to generate the verification code manually. For example, the app may receive a security matrix 402 and/or other one-time security data specifying operations to be performed in order to convert an item of critical transaction data (such as a recipient account number 702) into a corresponding verification code 706. The operations may include computing a hash of transformed critical transaction data, e.g. using an MD5, SHA-1, SHA-2, or other known hashing algorithm, and the verification code may be derived from the computed hash. In this case, it will be computationally impractical for an MIM/MIB attacker to derive the original transformed critical transaction data from the verification code, and therefore impossible for the attacker to determine the transformations applied to the critical transaction data. Thus the MIM/MIB attacker will be unable to generate its own verification code matching any fraudulently modified critical transaction data.

FIG. 8 is a schematic diagram of a system 800 for establishing a trusted backchannel between a secure service provider and a smart device app embodying the invention. As shown, a security system 326 with which the app will communicate has an associated private key 806 which is stored securely, such that it is not accessible to any potential attacker. The corresponding public key 804 is preloaded in the smart device app 806, which is made available to end-users through a trusted app store 808, such as the Apple App Store or Google Play, which ensures that apps originate with their stated source, and are not modified or otherwise tampered with prior to download to end-user devices 810. Once executing on an end-user device 804, the app is able to generate a unique encryption key, encrypt it using the preloaded public key 804, and transmit the encrypted encryption key to the security system 326. This unique encryption key can then be used for symmetrically encrypted communications between the security system 326 and the user smart device 804. For added security, the symmetric encryption key may be regenerated by the app on the user device 804 as frequently as desired, and in particular may be replaced after each use.

In an alternative embodiment, the information preloaded into the app which is available from the trusted app store 802 may be a unique telephone number associated with the security system 326, such that the app is able to recognise incoming SMS messages originating with the security system 326.

It should be appreciated that while particular embodiments and variations of the invention have been described herein, further modifications and alternatives will be apparent to persons skilled in the relevant arts. In particular, the examples are offered by way of illustrating the principles of the invention, and to provide a number of specific methods for putting those principles into effect. In general, embodiments of the invention rely upon providing technical arrangements whereby a verification code can be independently generated in two remote locations, e.g. at an end-user location and at a security system location, wherein the verification code is dependent upon at least one item of critical transaction data such that any modification of the critical transaction data in transit via a primary communications channel may be detected as a mismatch in the independently-generated verification codes. Arrangements embodying the invention employ a secondary channel to transmit one-time security data, which is used to generate the verification code, from the security system location to the end-user location. Systematically compromising the security provided by embodiments of the invention thus requires infiltration of both the primary and secondary communications channels.

Accordingly, the described embodiments should be understood as being provided by way of example, for the purpose of teaching the general features and principles of the invention, but should not be understood as limiting of the scope of the invention, which is defined in the appended claims.

1. A method of securing a transaction which includes one or more transaction messages transmitted to a transaction server via a first communications channel, the one or more transaction messages including at least one item of critical transaction data, wherein the method comprises:
receiving, by the transaction server via the first communications channel, a first transaction message, corresponding with a transaction request of a user, which includes an item of critical transaction data;
responsive to receipt of the first transaction message, generating one-time security data defining one or more operations to be performed based upon the critical transaction data in order to generate a transaction verification code;
transmitting the one-time security data to the user via a second communications channel which is functionally distinct from the first communications channel;
receiving, by the transaction server via the first communications channel, a second transaction message which includes a first transaction verification code provided by the user responsive to receipt of the one-time security data via the second communications channel;
generating a second transaction verification code by performing the operations defined by the one-time security data based upon the critical transaction data included in the received first transaction message;
comparing the first transaction verification code with the second transaction verification code; and
in the event of a mismatch between the first transaction verification code and the second transaction verification code, denying the transaction request.

2. The method of claim 1 wherein the one-time security data includes a security matrix which comprises a mapping between each symbol within a symbol set associated with the critical transaction data and a code value which is randomly selected from a code set, whereby the operations to be performed based upon the critical transaction data comprise generating a substitution code by replacing one or more symbols of the critical transaction data with the associated code value defined by the mapping.

3. The method of claim 2 wherein the security matrix is valid only for a duration of the transaction.

4. The method of claim 2 wherein the one-time security data further includes supplemental security data which defines one or more additional operations to be performed upon the substitution code in order to generate the transaction verification code.

5. The method of claim 4 wherein the one or more additional operations defined by the supplemental security data comprise selecting a subset of symbols of the substitution code for inclusion in the transaction verification code.

6. The method of claim 1 wherein the transaction verification code is derived from a hash of a code produced by performing operations defined by the one-time security data based upon the critical transaction data.

7. The method of claim 1 wherein the one-time security data is transmitted via the second communications channel to a user device for processing by a software application executing on the user device, the software application being configured to:
receive the one-time security data via the second communications channel;
request and receive from the user, via a user interface of the user device, the critical transaction data required for generation of the transaction security code by operations defined in the one-time security data;
generate the transaction verification code by performing the operations defined by the one-time security data based upon the critical transaction data received from the user; and
provide to the user, via the user interface of the user device, the generated transaction verification code.

8. A computer server system comprising a processor which is coupled to a memory store including executable program instructions which, when executed, cause the processor to:
provide a secure service portal accessible to a user via a first communications channel and configured to facilitate transactions in response to transaction requests of the user;
responsive to receiving, via the first communications channel, a first transaction message, corresponding with a transaction request of the user, which includes an item of critical transaction data, generate one-time security data defining one or more operations to be performed based upon the critical transaction data in order to generate a transaction verification code;
receive, via the first communications channel, a second transaction message which includes a first transaction verification code provided by the user responsive to receipt of the one-time security data, which has been transmitted to the user via a second communications channel which is functionally distinct from the first communications channel;
generate a second transaction verification code by performing the operations defined by the one-time security data based upon the critical transaction data included in the received first transaction message;
compare the first transaction verification code with the second transaction verification code; and
in the event of a mismatch between the first transaction verification code and the second transaction verification code, deny the transaction request.

9. The computer server system of claim 8 wherein the executable program instructions, when executed, cause the processor to generate the one-time security data by:
transmitting a request for generation of the one-time security data, via a secure communications channel, to a security system which is configured to generate the one-time security data.

10. The computer server system of claim 8 wherein the executable program instructions, when executed, cause the processor to generate the second transactrion verification code, and to compare the first transaction verification code with the second transaction verification code, by:
transmitting the first transaction verification code, via a secure communications channel, to a security system which is configured to generate the one-time security data; and
receiving from the security system, via the secure communications channel, a response message comprising an indication of a result of a comparison between the first transaction verification code and the second transaction verification code which has been generated by the security system performing the operations defined by the one-time security data based upon the critical transaction data included in the received first transaction message.

11. A security system comprising a processor which is coupled to a memory store including executable program instructions which, when executed, cause the processor to:
receive, from a remote processor via a secure communications channel, a request for generation of one-time security data;
generate one-time security data defining one or more operations to be performed based upon critical transaction data of a transaction of a user in order to generate a transaction verification code;
transmit, to a device of the user via a communications backchannel, a security message comprising the one-time security data;
receive, from the remote processor via the secure communications channel, a first transaction verification code generated by the user based upon the critical transaction data, and provided to the remote processor via a primary communications channel;
generate a second transaction verification code by performing the operations defined by the one-time security data based upon critical transaction data included in a transaction message sent by the user to the remote processor via the primary communications channel;
compare the first transaction verification code with the second transaction verification code; and
transmit, to the remote processor via the secure communications channel, a response message comprising an indication of a result of the comparison between the first transaction verification code and the second transaction verification code.

12. The security system of claim 11 wherein the executable program instructions, when executed, cause the processor to transmit the security message comprising the one-time security data to the device of the user via the remote processor.

13. A portable computing and communications device comprising a processor which is coupled to a memory store including executable program instructions which, when executed, cause the processor to:
receive, via an associated communications channel, one-time security data defining one or more operations to be performed based upon critical transaction data in order to generate a transaction verification code;
present to a user, via a user interface of the portable computing and communications device, a prompt for the user to enter the critical transaction data;
receive from the user, via the user interface, the critical transaction data;
generate the transaction verification code by performing the operations defined by the one-time security data based upon the critical transaction data; and
present to the user, via the user interface, a human-readable representation of the transaction verification code.

14. The portable computing and communications device of claim 13 wherein the executable program instructions, when executed, cause the processor to generate the transaction verification code in accordance with a method that includes computing a hash of transformed critical transaction data.

15. A computer program product comprising a computer-readable medium having executable program instructions stored therein which, when executed by a processor which is coupled to an associated communications channel, cause the processor to:
receive, via the associated communications channel, one-time security data defining one or more operations to be performed based upon critical transaction data in order to generate a transaction verification code;
present to a user, via a user interface, a prompt for the user to enter the critical transaction data;
receive from the user, via the user interface, the critical transaction data;
generate the transaction verification code by performing the operations defined by the one-time security data based upon the critical transaction data; and
present to the user, via the user interface, a human-readable representation of the transaction verification code.
